(19) United States
(12) Patent Application Publication
(10) Pub. No.: US 2004/0157573 A1
(43) Pub. Date: Aug. 12, 2004

(54) Circuit and method for DC offset calibration and signal processing apparatus using the same

(76) Inventors: Jung-Hwan Lee, Seongnam-si (KR); Jin-Kyu Lim, Seongnam-si (KR); Min-Su Jeong, Ahnyang-si (KR); Bon-Kee Kim, Youngin-si (KR); Bo-Eun Kim, Yongin-si (KR)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/772,292

(22) Filed: Feb. 6, 2004

(30) Foreign Application Priority Data
Feb. 7, 2003 (KR) 2003-7904

(51) Int. Cl. H04B 1/26

(52) U.S. Cl. 455/197.2; 455/240.1

(57) ABSTRACT

A method and circuit for compensating for a DC offset generated in a signal processing apparatus are disclosed. The signal processing apparatus comprises a low noise amplifier; a mixer for mixing the signals outputted from the low noise amplifier with a local oscillation signal; a first offset compensation amplifier for amplifying the output signals of the mixer and compensating for a DC offset existing in the output signals of the mixer firstly according to a first control signal applied thereto; a second offset compensation amplifier connected to the output of the first offset compensation amplifier to amplify signals inputted thereto, the second offset compensation amplifier compensating for a DC offset existing in the input signals secondarily according to a second control signal applied thereto; a variable gain amplifier for amplifying the output signals of the second offset compensation amplifier while controlling gain of the output signals; an offset detector for detecting a DC offset existing in the output signals of the variable gain amplifier; and an offset compensator for generating the first and second control signals to compensate for the DC offset detected by the offset detector.

### TECHNICAL FIELD

The present invention relates to a circuit for DC offset calibration and a signal processing apparatus using the same.

### BACKGROUND OF THE INVENTION

A direct conversion receiver that is one of receivers for restoring received signals is being studied actively. The direct conversion receiver directly converts an input radio frequency signal into a baseband signal without passing through a procedure of converting the input signal into an intermediate frequency signal. Thus, it is possible to decrease the number of external elements such as filters and alleviate a load of digital signal processing. This can reduce the cost and weight of the receiver and construct a one-chip system.

FIG. 1 is a block diagram of a conventional direct conversion receiver. Referring to FIG. 1, the conventional direct conversion receiver includes a low noise amplifier 101, a mixer 103, an amplifier 105, a filter 107 and a variable gain simplifier 109.

The low noise amplifier 101 is realized by a gain-controllable variable gain amplifier and amplifies a signal received through an antenna while suppressing noise of the signal. The mixer 103 mixes signals outputted from the low noise amplifier 101 with a local oscillation signal LO to output baseband signals. The amplifier 105 amplifies the baseband signals, and the filter 107 filters only a desired signal from the amplified signals. The variable gain amplifier 109 amplifies the signals outputted from the filter while controlling the gain of the signals in order to maintain a power level of a required output signal.

As described above, the direct conversion receiver shown in FIG. 1 can reduce the number of external elements such as filters and lessen a load of digital signal processing. However, it has a difficulty in constructing an integrated circuit due to a DC offset generated according to the following causes.

The principal cause of the DC offset in the direct conversion receiver is local oscillator leakage. Specifically, when a leakage component of a radio frequency signal is generated at the local oscillation signal input of the mixer 103 and the leakage component is reflected and applied to the mixer again, radio frequency signals received through the antenna are mixed with each other. Similarly, when a leakage component of the local oscillation signal LO is generated at the radio frequency signal input of the mixer 103 and this leakage component is reflected and inputted into the mixer 103 together with radio frequency signals, local oscillation signals are mixed with each other, to generate the DC offset. This DC offset is called DC offset by self-mixing. The quantity of the DC offset is not constant all the time but continuously varies with power r level and frequency of the radio frequency signal and the frequency of the local oscillation signal.

Secondly, mismatching of loads existing at the outputs of the mixer 103 and duty error of the local oscillation signal LO inputted to the mixer 103 generate the DC offset at the outputs of the mixer 103. Since the duty error of the local oscillation signal LO is varied with the frequency of the local oscillation signal LO, the DC offset caused by the duty error of the local oscillation signal LO is also varied according to the frequency of the local oscillation signal LO.

Thirdly, mismatching of amplifiers and filters included in a baseband circuit generates a DC offset in the output signal of the receiver. This DC offset varies with the cutoff frequency of the filter 107 and a variation in the gain of the variable gain amplifier 109.

As described above, the DC offset in the direct conversion receiver is generated according to various causes. Furthermore, the quantity of the DC offset is not constant all the time but continuously varies with the frequency of the local oscillation signal, a variation in a received signal and a variation in the gain of the amplifier while signals are received through the antenna.

The DC offset is the principal cause for deterioration of the performance of the direct conversion receiver so that studies for suppressing the DC offset in the direct conversion receiver are being carried out.

U.S. patent application Ser. No. 2002/0094788 proposes a technique for solving the DC offset problem of a receiver. FIG. 2 is a block diagram of a direct conversion receiver disclosed in the U.S. patent application Ser. No. 2002/0094788.

Referring to FIG. 2, the direct conversion receiver includes a dummy low noise amplifier 112B, first, second and third programmable gain amplifiers PGA1, PGA2 and PGA3, and first, second and third low pass filters LPF1, LPF2 and LPF3. DC offsets generated at the outputs of the first, second and third programmable gain amplifiers PGA1, PGA2 and PGA3 are removed using an automatic DC offset calibration circuit 117.

The automatic DC offset calibration circuit 117 includes analog-digital converters 124A, 124B and 124C, a register REG, digital-analog converter 125A, 125B and 125C and a counter 126. The analog-digital converters 124A, 124B and 124C convert potentials of the first, second and third programmable gain amplifiers PGA1, PGA2 and PGA3 into digital signals, respectively. The digital-analog converters 125A, 125B and 125C apply an offset to differential inputs of the first, second and third programmable gain amplifiers PGA1, PGA2 and PGA3 to make DC offsets of output signals of the first, second and third programmable gain amplifiers PGA1, PGA2 and PGA3 zero on the basis of output signals of the analog-digital converters 14A, 124B and 124C. The counter 126 provides operation timing to each of the digital-analog converters 125A, 125B and 125C.

The direct conversion receiver disclosed in U.S. patent application Ser. No. 2002/0094788 activates the dummy low noise amplifier 112B in the event of removal of DC offsets and provides an offset to the differential inputs of the first, second and third programmable gain amplifiers PGA1, PGA2 and PGA3 through the automatic offset calibration circuit 117, to thereby eliminate DC offsets generated at the outputs of the first, second and third programmable gain amplifiers PGA1, PGA2 and PGA3.

However, the offset calibration circuit 117 removes the DC offsets within a specific period of time. And, it eliminates only DC offsets caused by leakage of the local oscillation signal LO but is not able to remove a dynamic DC offset varying with time or a DC offset varying according to gain of an amplifier. Consequently, the dynamic DC offset that is varied with time or gain of an amplifier is amplified through the first, second and third programmable gain amplifiers PGA1, PGA2 and PGA3 to deteriorate the performance of the receiver. Furthermore, the dummy low noise amplifier 112B is used instead of the low noise amplifier 112A to which a radio frequency reception signal is applied in the event of removal of DC offsets so that the DC offset varied according to the power level of a radio frequency signal cannot be eliminated.

U.S. Pat. No. 6,225,848 and No. 6,114,980 disclose another techniques for solving the DC offset problem of a signal processor. The DC offset removal circuit disclosed in the patents includes a sign bit generator, a binary search stage and a digital-analog converter in order to remove the DC offset existing at the input of a gain stage. The gain stage amplifies the DC offset existing between input signals and applies the amplified DC offset to the sign bit generator. The sign bit generator outputs a positive or negative sign bit according to the DC offset inputted thereto. The binary search stage receives the sign bit from the sign bit generator to judge the direction for calibrating the DC offset and applies the DC offset calibration voltage to the input terminal of the amplifier, thereby removing the DC offset.

The aforementioned DC offset removal circuit forms a feedback loop to remove a DC offset in the receiver. However, it should open a low noise amplifier located at a front end of the receiver in order to eliminate the DC offset. Accordingly, a DC offset varying with the power level of a radio frequency signal cannot be removed.

### SUMMARY OF THE INVENTION

An object of the present invention is to provide a DC offset calibration circuit capable of eliminating a DC offset in a signal processing apparatus in real time.

Another object of the present invention is to provide a DC offset calibration circuit capable of eliminating a DC offset that varies according to a variation in the frequency of a local oscillation signal of a signal processing apparatus and a variation in the cutoff frequency of a filter circuit.

Still another object of the present invention is to provide a DC offset calibration circuit capable of removing a dynamic DC offset that varies with a variation in the power level of a signal applied to a signal processing apparatus.

Yet another object of the present invention is to provide a DC offset calibration circuit capable of removing a DC offset in a tuner of a receiver.

To accomplish the objects of the present invention, a signal processing apparatus in accordance of one aspect of the present invention comprises: a low noise amplifier; a mixer for mixing the signals outputted from the low noise amplifier with a local oscillation signal; a first offset compensation amplifier for amplifying the output signals of the mixer and compensating for a DC offset existing in the output signals of the mixer firstly according to a first control signal applied thereto; a second offset compensation amplifier connected to the output of the first offset compensation amplifier to amplify signals inputted thereto, the second offset compensation amplifier compensating for a DC offset existing in the input signals secondarily according to a second control signal applied thereto; a variable gain amplifier for amplifying the output signals of the second offset compensation amplifier while controlling gain of the output signals; an offset detector for detecting a DC offset existing in the output signals of the variable gain amplifier; and an offset compensator for generating the first and second control signals to compensate for the DC offset detected by the offset detector.

In the signal processing apparatus according to one aspect of the present invention, each of the first and second offset compensation amplifiers includes first and second amplification elements, first and second load impendances and a bias current source. Each of the first and second amplification elements has a gate, a drain and a source and controlling current flowing from the drain to the source according to an input voltage applied to the gate. The first and second load impedances are respectively connected between the drains of the first and second amplification element; and a first voltage source. The bias current source is connected between the sources of the first and second amplification elements and a second voltage source. Impedance values of the first and second load impedances are varied according to the first and second control signals applied thereto.

In the signal processing apparatus according to one aspect of the present invention, Each of the first and second offset compensation amplifiers includes third and fourth amplification elements and first and second bias current sources. Each of the third and fourth amplification elements has a gate, a drain and a source. The gates of the third and fourth amplification elements are respectively connected to the drains of the first and second amplification elements. Each of the third and fourth amplification elements outputs a voltage, reduced by a voltage across the gate and source from a voltage applied to the gate, to the source. The first and second bias current sources respectively supply variable current to the sources of the third and fourth amplification elements. The current supplied from the first and second bias current sources is varied with the first and second control signals.

In the signal processing apparatus according to one aspect of the present invention, the offset compensator includes a register and a counter, and the controller controls a data value stored in the register according to the polarity of the DC offset detected by the DC offset detector.

The signal processing apparatus according to one aspect of the present invention further comprises a filter for filtering a desired signal from the output signals of the first offset compensation amplifier to output the filtered signal to the second offset compensation amplifier.

In the signal processing apparatus according to one aspect of the present invention, the filter is constructed such that its cutoff frequency or its order can be varied.

In the signal processing apparatus according to one aspect of the present invention, the offset detector includes a comparator for comparing differential output signals of the first variable gain amplifier to each other.

In the signal processing apparatus according to one aspect of the present invention, the offset detector further includes means for sampling values outputted from the comparator and outputting an average value of the sampled values.

In the signal processing apparatus according to one aspect of the present invention, the offset detector further includes a filter for attenuating AC signals existing in the output signals of the variable gain amplifier to output them to the comparator.

In the signal processing apparatus according to one aspect of the present invention, in the case where the variable gain amplifier includes a plurality of variable gain amplifiers, the offset detector detects a DC offset generated between output signals of one of the plurality of variable gain amplifiers.

The signal processing apparatus according to one aspect of the present invention further comprises a switch connected between the second offset compensation amplifier and the DC offset compensator.

In the signal processing apparatus according to one aspect of the present invention, the register included in the DC offset compensator is a successive approximation register.

In the signal processing apparatus according to one aspect of the present invention, the DC offset compensator further includes a detector for detecting a variation in the frequency of the local oscillation signal or a variation in the cutoff frequency of the filter.

In the signal processing apparatus according to one aspect of the present invention, the DC offset compensator further includes a counter for increasing or decreasing the data value stored in the register according to the output value of the DC offset detector.

A signal processing in accordance with another aspect of the present invention includes: a low noise amplifier; a mixer for mixing the signals outputted from the low noise amplifier with a local oscillation signal; a first variable gain amplifier connected to the output of the mixer, to amplify signals inputted thereto while controlling gain of the input signals; means for eliminating a DC component existing in the output signals of the first variable gain amplifier, the means being connected to the output of the first variable gain amplifier; an offset compensation amplifier for receiving signals that have passed the means for removing the DC component and amplifying the signals, the offset compensation amplifier eliminating a DC component existing in the accepted signals according to a control signal applied thereto; a second variable gain amplifier for amplifying the output signals of the offset compensation amplifier while controlling gain of the output signals; an offset detector for detecting a DC offset existing in the output signals of the second variable gain amplifier; and an offset compensator for generating the control signal to compensate for the DC offset detected by the offset detector.

In the signal processing apparatus according to another aspect of the present invention, the means for eliminating the DC component existing in the output signals of the first variable gain amplifier includes a capacitor.

A signal processing apparatus in accordance with another aspect of the present invention comprises an offset compensation amplifier that different amplifies signals applied to its first and second inputs to output the amplified signals to its first and second outputs, the offset compensation amplifier compensating for a DC offset existing between signals inputted to the first and second inputs according to an offset control signal applied thereto; a variable gain amplifier for amplifying the output signals of the offset compensation amplifier while controlling gain of the output signals; an offset detector for detecting a DC offset existing in the output signals of the variable gain amplifier; and an offset compensator for outputting the control signal to compensate for the DC offset detected by the offset detector to the offset compensation amplifier.

In accordance with one aspect of the present invention, there is a method for compensating for a DC offset in a signal processing apparatus including the steps of: a first step of activating the signal processing apparatus; a second step of setting initial correction data used for compensating for a DC offset; a third step of detecting whether or not there is a variation in the frequency of a phase locked loop or a variation in the cutoff frequency of a low pass filter, the phase locked loop and the low pass filter being included in the signal processing apparatus; a fourth step of determining the most significant bit to the least significant bit of the correction data used for compensating for the DC offset through successive approximation to compensate for the DC offset in the case where the third step detects a variation; and a fifth step of detecting the DC offset generated in the signal processing apparatus in real time and increasing or decreasing the correction data value according to the detected DC offset, so as to compensate for the DC offset, when the third step does not detect any variation or the fourth step is finished.

In accordance with another aspect of the present invention, there is also a method for compensating for a DC offset in a signal processing apparatus, including the steps of: a first step of activating the signal processing apparatus; a second step of setting initial correction data used for compensating for a DC offset; a third step of determining the most significant bit to the least significant bit of the correction data used for compensating for the DC offset through successive approximation, to compensate for the DC offset; and a fourth step of detecting the DC offset generated in the signal processing apparatus in real time and increasing or decreasing the correction data value according to the detected DC offset, so as to compensate for the DC offset.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows a block diagram of a conventional direct conversion receiver;

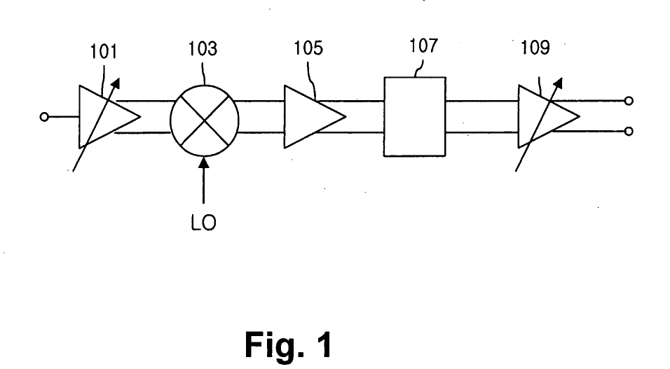

FIG. 2 shows a block diagram of a conventional direct conversion receiver including a DC offset compensation circuit;

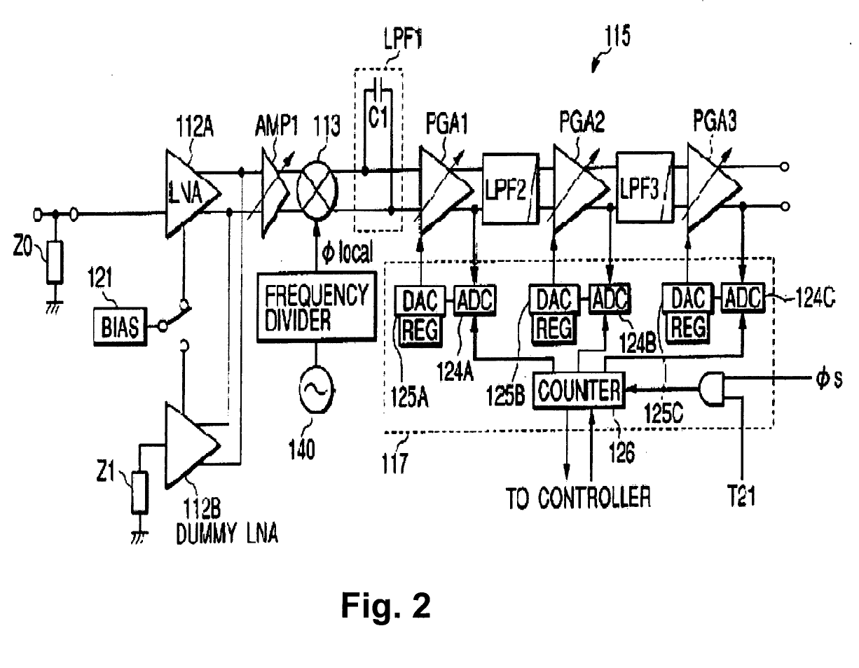

FIG. 3 shows a block diagram of a direct conversion receiver according to an embodiment of the present invention;

FIG. 4 shows a block diagram of a DC offset detector according to another embodiment of the present invention;

FIG. 5a shows a circuit diagram of a first amplifier shown in FIG. 3 according to an embodiment of the present invention;

FIG. 5b shows a circuit diagram of the first amplifier shown in FIG. 3 according to another embodiment of the present invention;

FIG. 6 shows a flow chart for showing a DC offset calibration method according to an embodiment of the present invention;

FIG. 7 shows a flow chart for showing a DC offset calibration method according to another embodiment of the present invention;

FIG. 8 shows a block diagram of a direct conversion receiver according to another embodiment of the present invention; and

FIG. 9 shows a block diagram of a direct conversion receiver according to another embodiment of the present invention.

### DETAILED DESCRIPTION OF THE INVENTION

Reference will now be made in detail to the preferred embodiments of the present invention, examples of which are illustrated in the accompanying drawings. In the following embodiments, the present invention is applied to a direct conversion receiver that is a signal processor where a DC offset is very problematical. However, a DC offset compensator according to the present invention can be applied to most signal processors having DC offset problems such as super heterodyne receiver in addition to the direct conversion receiver.

### Composition of a Direct Conversion Receiver According to an Embodiment of the Present Invention

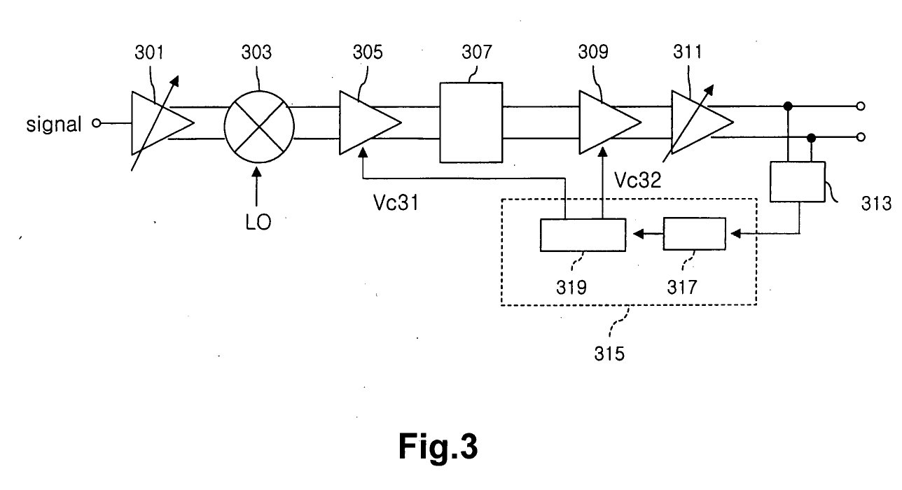

FIG. 3 shows a block diagram of a direct conversion receiver according to an embodiment of the present invention. Referring to FIG. 3, the direct conversion receiver according to an embodiment of the present invention includes a low noise amplifier 301, a mixer 303, first and second offset compensation amplifiers 305 and 309, a filter 307, a variable gain amplifier 311, an offset detector 313, and an offset compensator 315.

The low noise amplifier 301 amplifies or attenuates a signal received from an antenna, suppressing noise of the signal. As shown in FIG. 3, the low noise amplifier 301 can be realized by a variable gain amplifier and its gain can be controlled by an automatic gain controller (not shown).

The mixer 303 mixes the signals outputted from the low noise amplifier 301 with a local oscillation signal LO to output baseband signals.

The first offset compensation amplifier 305 amplifies the signals outputted from the mixer 303 and compensates for an offset in the signal inputted thereto according to a first control signal VC31.

The filter 307 filters only a desired signal from the signals amplified by the first offset compensation amplifier 305. In a communication system, a low pass filter is used as the filter 307 and it can be provided outside or inside a chip.

While the filter 307 is connected to the back of the first offset compensation amplifier 305 to filter the signals amplified by the first offset compensation amplifier 305 in FIG. 3, connection of the filter 307 can be varied in another embodiments.

The second offset compensation amplifier 309 amplifies the signals outputted from the filter 307 and compensates for a DC offset existing between input signals applied thereto according to a second control signal Vc32 supplied from by the offset compensator 315.

The variable gain amplifier 311 amplifies the output signals of the second offset compensation amplifier 309 while controlling the gain of the output signals. The gain of the variable gain amplifier 311 is controlled by the automatic gain controller and it maintains the power level of an output signal uniform.

The offset detector 313 compares differential output signals of the variable gain amplifier 311 to each other and detects a DC offset existing between the differential output signals to output it to the offset compensator 315. The offset compensator 315 includes a controller 317 and a register 319. The offset compensator 315 controls the first and second control signals Vc31 and Vc32 respectively applied to the first and second offset compensation amplifiers 305 and 309 according to an output value of the offset detector 313 to remove a DC offset generated at the output of the variable gain amplifier 311.

With the offset compensator 315 according to an embodiment of the present invention, the first control signal Vc31 is determined by upper N bits of the register 319 and the second control signal Vc32 is decided by lower M bits of the register 319.

In accordance with another embodiment of the present invention, a switch (not shown) can be connected between the second offset compensation amplifier 309 and the offset compensator 315. In this case, after the switch is closed, a DC offset generated at the variable gain amplifier 311 of a baseband stage is determined as lower M bits. Then, after the switch is opened, upper N bits are decided while maintaining the lower M bits, and then lower M bits are determined again. By doing so, a DC offset generated at the output of the direct conversion receiver can be eliminated accurately.

While the first and second offset compensation amplifiers 305 and 309 remove DC offsets existing in input signals according to the first and second control signals Vc31 and Vc32, it is an optimal embodiment to which the concept of the present invention is applied and the present invention is not limited to a specific number of offset compensation amplifiers. That is, only one offset compensation amplifier can be used for eliminating a DC offset. If required, at least three offset compensation amplifiers can be employed.

The composition and operation of the offset detector 313, the offset compensator 315, the first and second offset compensation amplifiers 305 and 309 are described below in detail.

### The Offset Detector According to an Embodiment of the Present Invention

As described above, the offset detector 313 compares differential output signals of the variable gain amplifier 311 to each other and detects a DC ofsset existing between the differential output signals to output it to the offset compensator 315.

In the direct conversion receiver according to an embodiment of the present invention, the offset detector 313 is composed of a comparator. In this case, the comparator compares the differential output signals of the variable gain amplifier 311 to each other and outputs 0 or 1 according to the polarity of a DC offset existing between the differential output signals, to thereby detect the DC offset generated in the output signals of the variable gain amplifier 311.

According to another embodiment of the present invention, the offset detector 313 may further include a counter connected to the output of the comparator. In this case, the comparator judges whether the DC offset in the output signals of the variable gain amplifier 311 is larger or smaller than 0. The counter samples the DC offset judged by the comparator and applies an average value of the sampling result to the offset compensator 315.

Specifically, in the case where sampling is carried out 64 times, for instance, a counter capable of counting from 0 to 127 is prepared. In this case, the initial value of the counter is set to 64 and the output signal of the comparator is monitored for each sampling. The counter reduces its output value when the output value of the comparator is 0 but increases it when the comparator outputs 1. Then, it is judged whether the output value of the counter is larger or smaller than 64 after 64 samplings are finished. By doing so, an erroneous operation, which may generate when the output signals of the variable gain amplifier 311 are mixed with an AC signal and applied to the comparator, can be prevented in advance.

Furthermore, the counter can be constructed in such a manner that the number of samplings and a sampling frequency are varied. A period of time required for outputting a detected DC offset to the offset compensator 315 can be represented by the value obtained by multiplying the sampling frequency (fs) by the number, (N) of samplings.

In the direct conversion receiver according to an embodiment of the present invention, when a conditional compensation mode operation, which will be described below, is carried out, the low noise amplifier 310 and the variable gain amplifier 311 ar set such that their gains become maximum values for the purpose of more accurate DC offset compensation. In this case, the output signal of the variable amplifier 311 of the baseband stage has very high power level when a radio frequency signal received through the antenna has a high power level. Accordingly, the output signals of the offset detector 313 repeat 0 and 1.

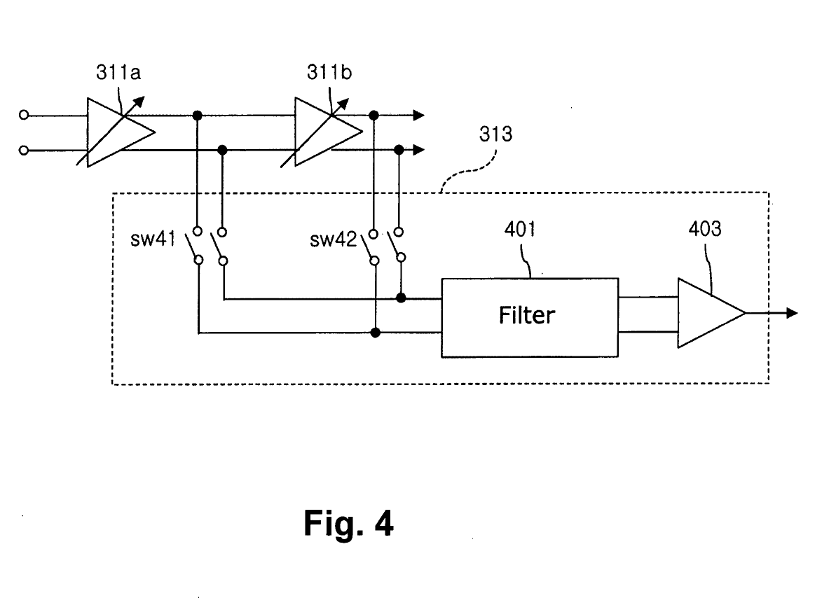

To solve this problem, as shown in FIG. 4, the offset detector 311 according to an embodiment of the present invention is constructed in a manner that a low pass filter 401 is connected between the outputs of variable gain amplifiers 311a and 311b and a comparator 403. In this configuration, the cutoff frequency of the low pass filter 401 is reduced so as to attenuate AC signals.

According to a preferred embodiment of the present invention, the low pass filter 401 can be a programmable low pass filter capable of controlling its cutoff frequency by software. In this case, as the cutoff frequency of the low pass filter 401 becomes smaller, AC signals are further attenuated. However, since lower cutoff frequency increases a signal transmission speed, an appropriate cutoff frequency is selected in order to allow the direct conversion receiver to perform an optimal operation. Furthermore, the low pass filter 401 can be composed of a filter having controllable order. In this case, though the internal composition of the filter 401 become, complicated as its order increases, affects of AC signals can be cancelled more. According to another embodiment of the present invention, it is possible to live hysteresis to the offset detector 313 to prevent erroneous operations caused by AC signals.

A second method for solving the problem caused by AC signals is to detect a DC offset from the output of the variable gain amplifier 311a placed before the final output stage 311b or from the output of a variable gain amplifier located before the variable gain amplifier 311a in the case where the variable gain amplifier 311 is composed of multiple variable gain amplifiers 311a and 311b, as shown in FIG. 4. In this case, an AC signal with lower level is applied to the offset detector 313 so that affects of AC signals can be further suppressed when a DC offset is detected.

### The Offset Compensator According to an Embodiment of the Present Invention

As described above, the offset compensator 315 includes the controller 317 and the register 319 and controls the first and second control signals Vc31 and Vc32 respectively applied to the first and second offset compensation amplifiers 315 and 309 to remove a DC offset existing at the outputs of the variable gain amplifier 311.

The controller 317 included in the offset compensator 315 controls, a data value stored in the register 317 according to the polarity of a DC offset detected by the offset detector 313. A part or all parts of data stored in the register 317 is applied to the first and second offset compensation amplifiers 305 and 309 as the first and second control signals Vc31 and Vc32. Specifically, in the case where the offset detector 313 is composed of a comparator, the controller 317 judges whether the output value of the comparator is 0 or 1 and varies a data value stored in the register 319.

In the offset compensator 315 according to an embodiment of the present invention, the register 319 can be a successive approximation register. In this case, the controller 317 determines the most significant bit to the least significant bit of a data value of the register 319 through successive approximation according to a DC offset detected by the offset detector 313 so as to convert the DC offset into digital data.

In the offset compensator 315 according to an embodiment of the present invention, the first control signal Vc31 is composed of upper N-bit digital data stored in the register 315 of the offset compensator 315. In this case, the first offset compensation amplifier 305 receives the first control signal Vc31 to compensate for a DC offset with a predetermined full range as resolution of the N bits.

Similarly, the second control signal Vc32 is composed of lower M-bit digital data stored in the register 319. In this case, the second offset compensation amplifier 309 accepts the second control signal Vc32 to compensate for a DC offset existing between input signals of the second offset compensation amplifier 309.

In the offset compensator 315 according to an embodiment of the present invention, preferably, the second offset compensation amplifier 309 receives the lower M-bit data to compensate for the DC offset, having the full range corresponding to 2 least significant bits of th first offset compensation amplifier 309 as resolution of the M bits. The second offset compensation amplifier 309 has the full range corresponding to 2 least significant bits of the first offset compensation amplifier 305 in order to prevent the case where a DC offset cannot be accurately compensated with data stored in the register 319 due to a DC offset generated caused by the first offset compensation amplifier 305 and the filter 307.

### The offset Compensation Amplifiers According to an Embodiment of the Present Invention

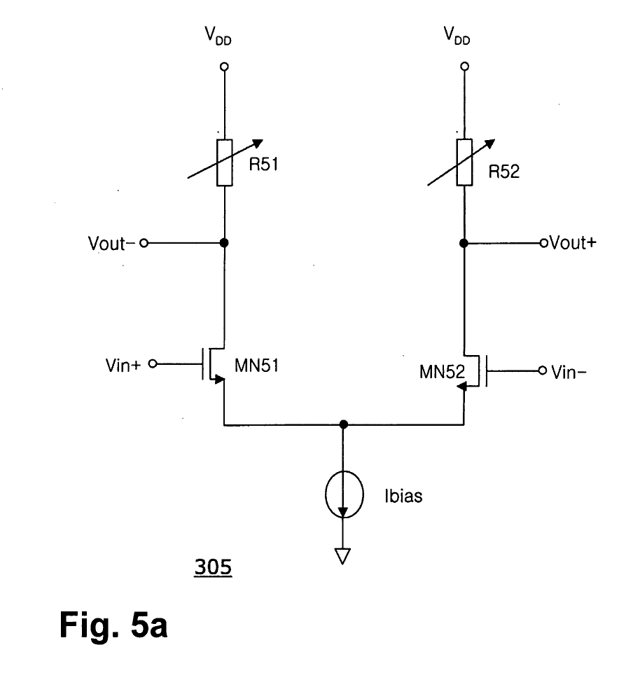

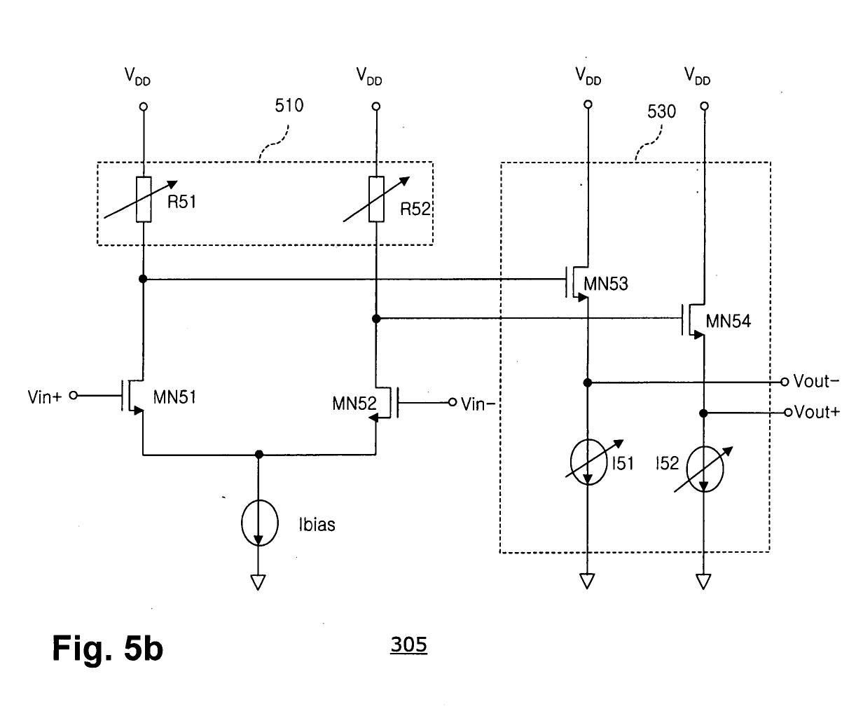

FIGS. 5a is a circuit diagram showing the internal configuration of the first offset compensation amplifier 305 shown in FIG. 3. Referring to FIG. 5a, the first offset compensation amplifier 305 according to an embodiment of the present invention includes first and second amplification elements MN51 and MN52, a bias current source Ibias, first and second load impedances R51 and R52.

When the first and second amplification elements MN51 and MN52 control currents flowing to their drains according to input signals Vin+ and Vin− respectively applied to their gates, the quantity of voltage drop caused by the first and second load impedances R51 and R52 is varied. As a result, signals with amplified voltages of the inputs Vin+ and Vin− are respectively outputted to positive and negative outputs Vout+ and Vout1.

In the first offset compensation amplifier 305 according to an embodiment of the present invention, the first and second load impedances R51 and R52 are variable impedances whose values are varied according to a control signal applied thereto. Specifically, the first control signal Vc31 according to the offset compensator 315 is applied to the first and second load impedances R51 and R52 of the first offset compensation amplifier 305. The first and second load impedances R51 and R52 have different impedance values according to the first control signal Vc31. That is, levels of voltages dropped by the first and second load impedances R51 and R52 have a difference between them, which corresponds to a DC offset existing between input signals Vc+ and Vc−, so as to compensate for the DC offset.

FIG. 5b is a circuit diagram of the first offset compensation amplifier 305 according to another embodiment of the present invention. The circuit configuration shown in FIG. 5b is for removing the DC offset existing between the input signals Vc+ and Vc− more accurately. In this case, a second compensation unit 530 is added to the composition of FIG. 5a.

The second compensation unit 530 includes third and fourth amplification elements MN53 and MN54, first and second current sources I51 and I52. The third amplification element MN53 is serially connected with the first current source I51 while the fourth amplification element MN54 is serially connected with the second current source I52. The gate of the third amplification element MN53 is coupled to the drain of the first amplification element MN51, and the gate of the fourth amplification element MN54 is connected to the drain of the second amplification element MN52. The sources of the third and fourth amplification elements MN53 and MN54 form negative and positive output terminals Vout− and Vout+, respectively.

In the first offset compensation amplifier 305 according to another embodiment of the present invention, upper a bits of the first control signal Vc31 are applied to the first and second load impedances R51 and R52 of a first compensation unit 510, and lower b bits of the first control signal Vc31 are applied to the first and second current sources I51 and I52 of the second compensation unit 530.

The operation of the first offset compensation amplifier 305 according to another embodiment of the present invention is described below.

As described above, the first compensation unit 510 makes impedance values of the first and second load impedances R51 and 52 different from each other according to the control signal applied thereto, so as to eliminate a DC offset existing between the input signals Vin+ and Vin−.

The second compensation unit 530 reduces the output voltage of the amplifier circuit shown in FIG. 5a by a voltage applied across the gate and source of the third and fourth amplification elements MN53 and MN54 to increase frequency swing of the output signal. In addition, the second compensation unit 530 controls the first and second current sources I51 and I52 to have different values so as to remove the DC offset existing between the input signals Vin+ and Vin− more accurately.

More specifically, the first and second current sources I51 and I52 are varied to change the voltage Vgs across the gate and source of the third and fourth amplification elements MN53 and MN54. This varies DC voltage applied to the positive and negative output terminals Vout+ and Vout−. Here, the varying DC voltage is in proportion to a value corresponding to the root of varied current. Accordingly, the second compensation unit 530 can compensate for the DC offset between the input signals more accurately than the first compensation unit 510 where a correction voltage is proportional to current.

The first offset compensation amplifier 305 that eliminates the DC offset existing between input signals according to the first control signal Vc31 applied by the offset compensator 315 has been explained with reference to FIGS. 5a and 5b. Similarly, the second offset compensation amplifier 309 can be constructed in such a manner that the DC offset between input signals is removed according to that second control signal Vc32 applied by the offset compensator 315. The second offset compensation amplifier 309 can have the same composition as that of the first offset compensation amplifier 305 or adopt a varied structure.

### Offset Compensation According to an Embodiment of the Present Invention

The offset compensator 315 according to an embodiment of the present invention supports the conditional compensation mode operation and real-time compensation mode operation.

The conditional compensation mode operation compensates for a DC offset generated between output signals of the direct conversion receiver when the frequency of the local oscillation signal LO or the cutoff frequency of the filter 307 is changed. The real-time compensation mode operation compensates for the DC offset generated between output signals of the direct conversion receiver in real time.

The conditional compensation mode operation is explained first.

As described above, the DC offset generated between output signals of the receiver varies with a variation in the frequency of the local oscillation signal LO or a variation in the cutoff frequency of the filter 307. Thus, a variation in the frequency of the local oscillation signal LO or a variation in the cutoff frequency of the filter 307 is detected and the conditional compensation mode operation is carried-out when there a detected variation.

In this case, the offset compensator 315 shown in FIG. 3 further includes a detector (not shown) for detecting if there is a variation in the register that controls the frequency of the local oscillation signal LO and the cutoff frequency of the filter 307. The conditional compensation mode operation is carried out according to the output signal of the detector.

In the course of the conditional compensation mode operation, the offset compensator 315 determines the most significant bit to the least significant bit of the data value of the register 319 for controlling the first and second offset compensation amplifiers 305 and 309 through successive approximation.

Specifically, the register 319 included in the offset compensator 315 is set such that the first and second offset compensation amplifiers 305 and 309 have a compensation voltage corresponding to the middle value of the full range in the initial state. In this case, a voltage value obtained by subtracting the compensation value from the existing DC offset is outputted to the output of the variable gain amplifier 311 of the baseband stage. This value is applied to the offset detector 313. The offset detector 313 detects a DC offset existing in input signals applied thereto and supplies the DC offset to the offset compensator 315. Then, the controller 317 of the offset compensator 315 determines the most significant bit of the register 319.

More specifically, in the case where the offset detector 313 is composed of a comparator, the output of the offset detector 313 becomes 1 when the detected DC offset is a positive value but it is 0 when the DC offset is a negative value. Accordingly, the controller 317 of the offset compensator 315 judges whether the output value of the offset detector 313 is 0 or 1 and sets a corresponding bit of the register 319 to 1 when the output value is 1. On the contrary, the controller 317 sets a corresponding bit of the register 319 to 0 when the output value is 0. In this manner, the offset compensator 315 determines the most significant bit to the least significant bit of the data value of the register 319 to complete the conditional compensation mode operation.

While the conditional compensation mode operation is carried out when the frequency of the local oscillation signal or the cutoff frequency of the filter is changed in the above-described embodiment, it is also possible to perform the conditional compensation mode operation once or more irrespective of a variation in the frequency of the local oscillation signal or a variation in the cutoff frequency of the filter and then carry out the real-time compensation mode operation which will be explained below.

The conditional compensation mode operation for compensating for a DC offset generated between output signals of the direct conversion receiver when the frequency of the local oscillation signal LO or the cutoff frequency of the filter 307 is changed has been described above. However, a DC offset at the outputs of the mixer 303 is changed when the power level of a radio frequency signal received through the antenna is varied even if the DC offset generated between output signals of the receiver has been compensated through the conditional compensation mode operation. This changes the control signal of the automatic gain controller to result in a variation in the DC offset of the variable gain amplifier 311. To compensate for the variation in the DC offset, the offset compensator 315 carries out the real-time compensation mode operation while maintaining the data value of the register 319, determined by the conditional compensation mode operation.

In the direct conversion receiver according to an embodiment of the present invention, the real-time compensation mode operation compensates for a varied DC offset by increasing or decreasing the data value stored in the register 319 through the controller 319 according to the polarity of the DC offset detected by the offset detector 313. Preferably, the controller 317 of the offset compensator 315 controls the register 319 from the least significant bit to the most significant bit.

In the direct conversion receiver according to an embodiment of the present invention, the controller 319 further includes an up-down counter to increase or decrease the value of the register 319 in the real-time compensation mode operation.

As described above, the direct conversion receiver according to an embodiment of the present invention can eliminate a DC offset generated therein through the conditional compensation mode operation and the real-time compensation mode operation. Furthermore, the receiver can compensate for the DC offset in real time to remove a dynamic DC offset varying with the power level of a received signal and gains of amplifiers.

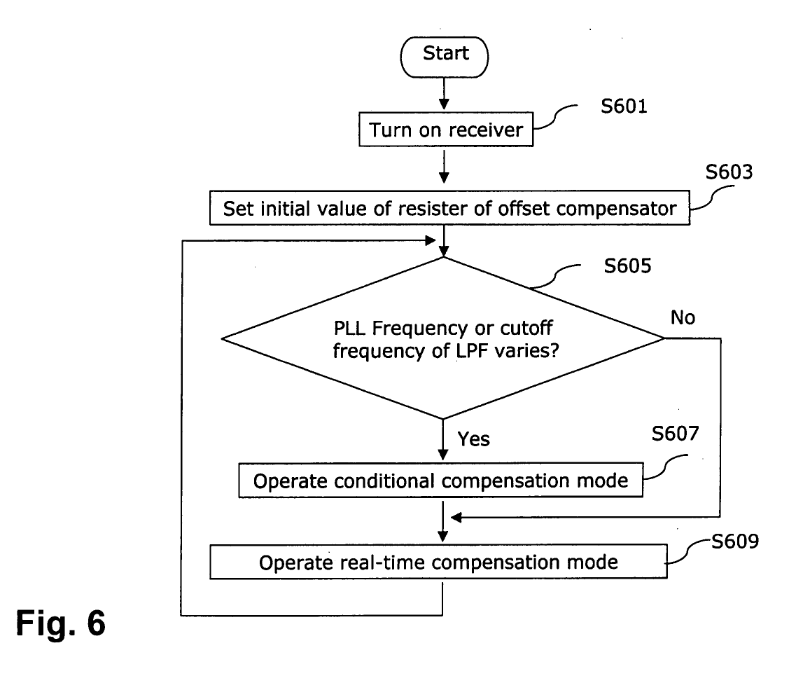

FIG. 6 is a flow chart for explaining an offset compensation method according to an embodiment of the present invention. Referring to FIG. 6, the receiver is turned on at step S601, and the initial value of the register 319 included in the offset compensator 315 is set at step S603. The offset compensator 315 detects if there is a variation in the register that controls the frequency of a phase locked loop for generating the local oscillation signal LO or in the cutoff frequency of the filter 307 at step S605. Here, when the frequency of the phase locked loop or the cutoff frequency of the filter 317 is varied, the offset compensator carries out the conditional compensation mode operation at step S607. When all of bit values of the register 319 are determined according to the conditional compensation mode operation, the real-time compensation mode operation is performed while maintaining the determined data values, to remove a dynamic DC offset, at step S609.

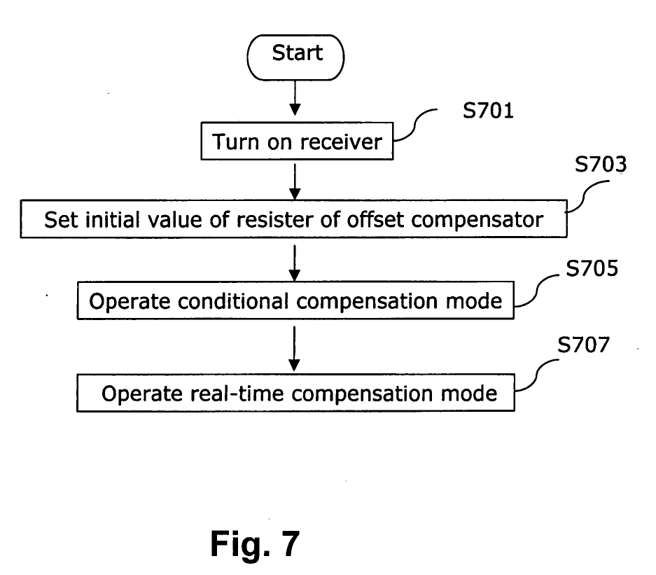

FIG. 7 is a flow chart for explaining a DC offset compensation method according another embodiment of the present invention. In this case, after the initial value of the register is set at step S703, the conditional compensation mode operation is carried out irrespective of a variation in the frequency of the phase locked loop or a variation in the cutoff frequency of the filter, at step S705. Then, the real-time compensation mode operation for canceling a DC offset varying with a variation in the gain of the variable gain amplifier is executed while receiving signals continuously, at step S707.

### A Direct Conversion Receiver According to Another Embodiment of the Present Invention

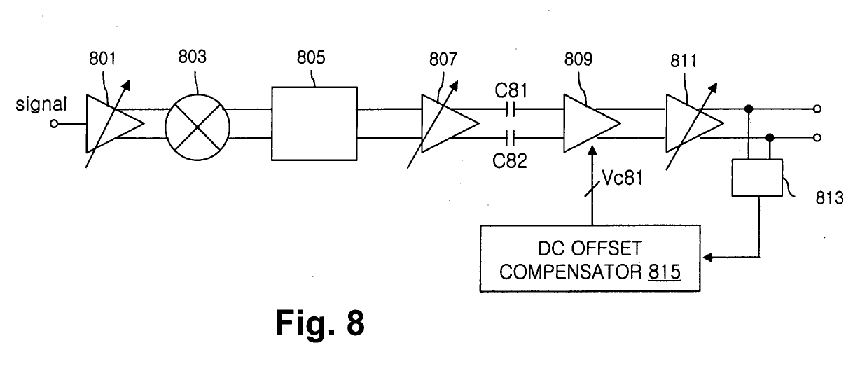

FIG. 8 is a block diagram of a direct conversion receiver according to another embodiment of the present invention. As shown in FIG. 8, the direct conversion receiver according to another embodiment of the present invention is suitable for processing of wide-band signals such as direct broadcasting satellite signals. The composition and operation of the direct conversion receiver according to another embodiment of the present invention are described below with reference to FIG. 8. Explanation for the composition and operation of the same parts as those described in FIG. 3 will be omitted.

Referring to FIG. 8, the direct conversion receiver according to another embodiment of the present invention is constructed in such a manner that a filter 805, first and second variable gain amplifiers 807 and 811, first and second capacitors C81 and C82 and an offset compensation amplifier 809 are sequentially connected to the output of a mixer 803. The filter 807 filters a desired signal from output signals of the mixer 803 and the first variable gain amplifier 807 amplifies the output signals of the filter 807 while controlling the gain of the output signals.

The first and second capacitors C81 and C82 are respectively connected to both outputs of the first variable gain amplifier 807 to restrain a DC component existing in the output signals of the first variable gain amplifier 807 and low-frequency components near to the DC component from being transmitted to the offset compensation amplifier 809.

The offset compensation amplifier 809 amplifies input signals applied thereto and eliminates a DC offset generated between the input signals according to a first control signal Vc81 supplied from an offset compensator 615. The second variable gain amplifier 811 amplifies output signals of the offset compensation amplifier 809 while controlling the gain of the output signals.

In the case where a DC component is blocked using AC coupling between the first and second variable gain amplifiers 807 and 811, as shown in FIG. B, the range of a DC offset to be compensated is reduced so that the DC offset can be compensated with a smaller number of bits. However, this technique must be properly used depending on a signal processing apparatus to which the present invention is applied because low frequency signals are lost.

While the first and second capacitors C81 and C82 are connected to the outputs of the first variable gain amplifier 807 for obtaining AC coupling in the composition shown in FIG. 8, a variety of methods for suppressing the DC component of the output signals of the first variable gain amplifier 807 can be employed.

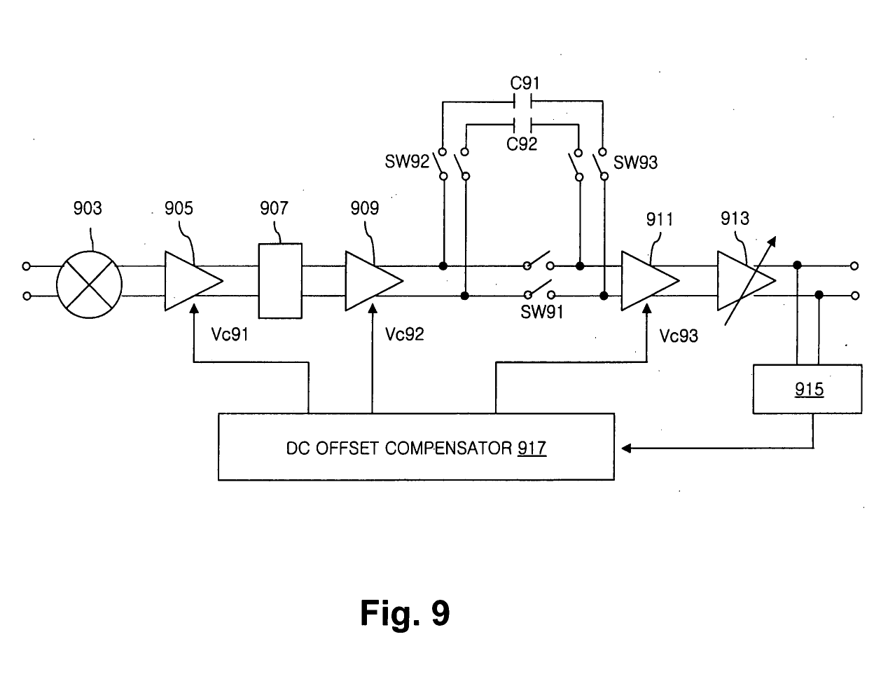

FIG. 9 is a block diagram of a direct conversion receiver according to another embodiment of the present invention. As shown in FIG. 9, the direct conversion receiver according to another embodiment of the present invention can selectively use the offset compensation methods shown in FIGS. 3 and 8.

Specifically, in the case where the DC offset compensation method shown in FIG. 3 is used, a first pair of switches SW91 is closed but second and third pairs of switches SW2 and SW93 are opened. Accordingly, signals amplified by first and second offset compensation amplifiers 905 and 909 are applied to a third offset compensation amplifier 911. In this case, an offset compensator 917 respectively applies first and second control signals Vc91 and Vc92 to the first and second offset compensation amplifiers 905 and 909, to eliminate a DC offset generated between output signals of a variable gain amplifier 913. Furthermore, the third offset compensation amplifier 911 amplifies and transmits output signals of the second offset compensation amplifier 909 irrespective of the DC offset compensation operation.

In the case where a DC offset is removed through the method shown in FIG. 8, the first pair of switches SW91 is opened and the second and third pairs of switches SW92 and SW93 are closed. Accordingly, the output signals of the second offset compensation amplifier 909 are applied to the third offset compensation amplifier 911 through first and second capacitors C91 and C92. The third offset compensation amplifier 911 compensates for a DC offset according to a third control signal Vc93. In this case, the first and second offset compensation amplifiers 905 and 909 amplify signals irrespective of the DC offset compensation operation. The first and second capacitors C91 and C92 can be provided inside or outside a chip. It is preferable to provide the capacitors outside the chip when they have large capacitance.

### INDUSTRIAL APPLICABILITY

According to the present invention, a DC offset generated in a signal processing apparatus can be removed in real time. Furthermore, it is possible to eliminate a DC offset generated caused by a variation in the frequency of a local oscillation signal of the signal processing apparatus or a variation in the cutoff frequency of a filter. Moreover, a dynamic DC offset varying with a variation in the power level of a signal applied to the signal processing apparatus can be removed in real time.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A signal processing apparatus, comprising:
a low noise amplifier;
a mixer for mixing the signals outputted from the low noise amplifier with a local oscillation signal;
a first offset compensation amplifier for amplifying the output signals of the mixer and compensating for a DC offset existing in the output signals of the mixer firstly according to a first control signal applied thereto;
a second offset compensation amplifier connected to the output of the first offset compensation amplifier to amplify signals inputted thereto, the second offset compensation amplifier compensating for a DC offset existing in the input signals secondarily according to a second control signal applied thereto;
a variable gain amplifier for amplifying the output signals of the second offset compensation amplifier while controlling gain of the output signals;
an offset detector for detecting a DC offset existing in the output signals of the variable gain amplifier; and
an offset compensator for generating the first and second control signals to compensate for the DC offset detected by the offset detector.

2. The signal processing apparatus according to claim 1, wherein each of the first and second offset compensation amplifiers includes each of first and second amplification elements having a gate, a drain and a source and controlling current flowing from the drain to the source according to an input voltage applied to the gate,
first and second load impedances being respectively connected between the drains of the first and second amplification elements and a first voltage source, and
a bias current source being connected between the sources of the first and second amplification elements and a second voltage source,
wherein impedance values of the first and second load impedances are varied according to the first and second control signals applied thereto.

3. The signal processing apparatus according to claim 2, wherein
each of the first and second offset compensation amplifiers includes each of third and fourth amplification elements having a gate being respectively connected to the drains of the first and second amplification elements, a drain and a source, and outputting a voltage reduced by a voltage across the gate and source from a voltage applied to the gate to the source, and
first and second bias current sources respectively supplying variable current to the sources of the third and fourth amplification elements,
wherein the current supplied from the first and second bias current sources are varied according to the first and second control signals.

4. The signal processing apparatus according to claim 1, wherein the offset compensator includes a register and a controller, and the controller controls a data value stored in the register according to the polarity of the DC offset detected by the DC offset detector.

5. The signal processing apparatus according to claim 1, further comprising a filter for filtering a desired signal from the output signals of the first offset compensation amplifier to output the filtered signal to the second offset compensation amplifier.

6. The signal processing apparatus according to claim 5, wherein the filter is constructed such that its cutoff frequency or an order of the filter can be varied.

7. The signal processing apparatus according to claim 1, wherein the offset detector includes a comparator for comparing differential output signals of the first variable gain amplifier to each other.

8. The signal processing apparatus according to claim 7, wherein the offset detector further includes means for sampling values outputted from the comparator and outputting an average value of the sampled values.

9. The signal processing apparatus according to claim 1, wherein the offset detector further includes a filter for attenuating AC signals existing in the output signals of the variable gain amplifier to output them to the comparator.

10. The signal processing apparatus according to claim 1, wherein, in the case where the variable gain amplifier includes a plurality of variable gain amplifiers, the offset detector detects a DC offset generated between output signals of one of the plurality of variable gain amplifiers.

11. The signal processing apparatus according to claim 1, further comprising a switch connected between the second offset compensation amplifier and the DC offset compensator.

12. The signal processing apparatus according to claim 1, wherein the register included in the DC offset compensator is a successive approximation register.

13. The signal processing apparatus according to claim 1, wherein the DC offset compensator further includes a detector for detecting a variation in the frequency of the local oscillation signal or a variation in the cutoff frequency of the filter.

14. The signal processing apparatus according to claim 4, wherein the DC offset compensator further includes a counter for increasing or decreasing the data value stored in the register according to the output value of the DC offset detector.

15. A signal processing apparatus, comprising:
a low noise amplifier;
a mixer for mixing the signals outputted from the low noise amplifier with a local oscillation signal;
a first variable gain amplifier connected to the output of the mixer, to amplify signals inputted thereto while controlling gain of the input signals; means for eliminating a DC component existing in the output signals of the first variable gain amplifier, the means being connected to the output of the first variable gain amplifier;
an offset compensation amplifier for receiving signals that have passed the means for removing the DC component and amplifying the signals, the offset compensation amplifier eliminating a DC component existing in the accepted signals according to a control signal applied thereto;
a second variable gain amplifier for amplifying the output signals of the offset compensation amplifier while controlling gain of the output signals;
an offset detector for detecting a DC offset existing in the output signals of the second variable gain amplifier; and
an offset compensator for generating the control signal to compensate for the DC offset detected by the offset detector.

16. The signal processing apparatus according to claim 15, wherein the means for eliminating the DC component existing in the output signals of the first variable gain amplifier includes a capacitor.

17. A signal processing apparatus, comprising:
an offset compensation amplifier that differential-amplifies signals applied to its first and second input terminals to output the amplified signals to its first and second output terminals, the offset compensation amplifier compensating for a DC offset existing between signals inputted to the first and second inputs according to an offset control signal applied thereto;
a variable gain amplifier for amplifying the output signals of the offset compensation amplifier while controlling gain of the output signals;
an offset detector for detecting a DC offset existing in the output signals of the variable gain amplifier; and
an offset compensator for outputting the control signal to compensating for the DC offset detected by the offset detector to the offset compensation amplifier.

18. A method for DC offset calibration in a signal processing apparatus, comprising the steps of:
a first step of activating the signal processing apparatus;
a second step of setting initial correction data used for compensating for a DC offset;
a third step of detecting whether or not there is a variation in the frequency of a phase locked loop or a variation in the cutoff frequency of a low pass filter, the phase locked loop and the low pass filter being included in the signal processing apparatus;
a fourth step of determining from the most significant bit to the least significant bit of the correction data used for compensating for the DC offset through successive approximation to compensate for the DC offset in the case where the third step detects a variation; and
a fifth step of detecting the DC offset generated in the signal processing apparatus in real time and increasing or decreasing the correction data value according to the detected DC offset, so as to compensate for the DC offset, when the third step does not detect any variation or the fourth step is finished.

19. A method for DC offset calibration in a signal processing apparatus, comprising the steps of:
a first step of activating the signal processing apparatus;
a second step of setting initial correction data used for compensating for a DC offset;
a third step of determining from the most significant bit to the least significant bit of the correction data used for compensating for the DC offset through successive approximation, to compensate for the DC offset; and
a fourth step of detecting the DC offset generated in the signal processing apparatus in real time and increasing or decreasing the correction data value according to the detected DC offset, so as to compensate for the DC offset.
